(19) United States
(12) Patent Application Publication
(10) Pub. No.: US 2020/0061886 A1
(43) Pub. Date: Feb. 27, 2020

(54) HEADLINER AND METHOD OF PRODUCING SAME

(71) Applicant: FORD GLOBAL TECHNOLOGIES, LLC, Dearborn, MI (US)

(72) Inventors: Paul Alan Forgette, Brownstown, MI (US); Amy M. Boardman, Garden City, MI (US); John Andrew Stakoe, Bloomfield Hills, MI (US); Anna Miller Hill, Belleville, MI (US); Robert Ralph Armitage, JR., Howell, MI (US)

(21) Appl. No.: 16/107,923

(22) Filed: Aug. 21, 2018

(51) Int. Cl. B29C 45/14; B29C 51/16; B29C 51/12; B60R 13/02

(52) U.S. Cl. CPC B29C 45/1418; B29C 51/165; B29K 2023/12; B60R 13/0212; B29C 2791/001; B29C 51/12

(57) ABSTRACT

A headliner includes a unitary body having a substrate with an A-surface and a B-surface, a secondary component carried on the B-surface and a laminated surface covering on the A-surface. That method of producing that headliner with a unitary body is also provided.

### TECHNICAL FIELD

This document relates generally to the motor vehicle equipment field and, more particularly, to a new and improved headliner for a motor vehicle as well as to a new and improved method for making that headliner.

### BACKGROUND

State of the art processes for producing vehicle headliners or overhead systems rely upon many different types of materials, tools and processes from various supplier companies. Those supplier companies may be located near and far from the original equipment manufacturer and a complex network of shipping logistics is required to ensure production schedules are met. In addition, many types of tools, equipment, processes, materials and people are required to assemble the various parts into the vehicle headliner or overhead system.

This document relates to a new and improved production process specifically adapted for producing motor vehicle headliners or overhead systems in a more cost effective and efficient manner. In order to achieve this goal, the processes of thermoforming the polypropylene glass matte technology (PP/GMT) into a headliner substrate and injection molding a secondary component onto the headliner substrate have been combined into a new hybrid process that culminates in a subsequent step of laminating a surface covering onto the headliner substrate. By simultaneously molding the secondary components to the headliner substrate as the headliner substrate is being formed, engineering/design time, part cost and tooling efficiencies are improved by reducing many of the component tools, processes and logistics that are required to make the motor vehicle headliner or overhead system.

### SUMMARY

In accordance with the purposes and benefits as described herein, a new and improved headliner is provided. That headliner comprises a unitary body including (a) a substrate having an A-surface and a B-surface, (b) a secondary component carried on the B-surface and (c) a laminated surface covering on the A-surface.

More particularly, the secondary component may comprise a side air curtain deployment feature. In an alternative embodiment of the headliner, the secondary component may comprise an integral attachment feature. That integral attachment feature may comprise a bracket. In one or more of the many possible embodiments of the headliner, the bracket may include a receiver adapted to receive and hold a magnetic fastener.

In one or more of the many possible embodiments of the headliner, the secondary component may comprise an integral reinforcement. In one or more of the many possible embodiments, that integral reinforcement may comprise a plurality of ribs.

In one or more of the many possible embodiments of the headliner, the secondary component may comprise an integral energy absorbing feature. That integral energy absorbing feature may comprise a plurality of energy absorbing ribs.

In one or more of the many possible embodiments of the headliner, the secondary component may comprise a trim ring. That trim ring may include a receiver adapted to receive a sun roof of assembly and reinforce the sun roof opening provided in the headliner.

In accordance with yet another aspect, a method is provided of producing a headliner with a unitary body. That method comprises the steps of thermoforming a blank into a headliner substrate, simultaneously injection molding a secondary component onto the headliner substrate and then laminating a surface covering to the headliner substrate. The secondary component is selected from a group of secondary components consisting of a side air curtain deployment feature, an integral attachment feature, a bracket, a bracket including a receiver adapted to receive and hold a magnetic fastener, an integral reinforcement, a plurality of ribs, an integral energy absorbing feature and combinations thereof.

More specifically, the method may further include the step of heating the blank prior to thermoforming and injection molding. Further, the method may include the step of loading the pre-heated blank into a combined thermoforming and injection molding apparatus following heating.

The method may further include the step of trimming the headliner substrate following the thermoforming and injection molding and before laminating. Still further, the method may include the step of transferring the headliner substrate from the combined thermoforming and injection molding apparatus into a laminating press for the laminating process to be completed.

In the following description, there are shown and describe several preferred embodiments of the new and improved headliner and the related method of producing a headliner with a unitary body. As it should be realized, the method and headliner are capable of other, different embodiments and their several details are capable of modification in various, obvious aspects all without departing from the method and headliner as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the method together with the description serve to explain certain principles thereof.

FIG. 1 is a schematic illustration of the method illustrating the oven for heating the blank from which the headliner substrate is thermoformed, the combined thermoforming and injection molding apparatus that simultaneously thermoforms the blank into the headliner substrate and injection molds a secondary component onto the B surface of the headliner substrate and the laminating press utilized to subsequently laminate a surface covering onto the A surface of the headliner substrate.

FIG. 2 is a schematic block diagram of the method of producing the headliner with a unitary body.

FIG. 3 is a perspective view of one possible embodiment of the unitary body headliner produced by the method illustrated in FIGS. 1 and 2 wherein the secondary component provided on the B surface of the headliner substrate is a side air curtain deployment feature.

FIG. 4 is a perspective view of an alternative embodiment of the unitary body headliner wherein the secondary component is an integral attachment feature in the form of a bracket and an integral reinforcement in the form of a plurality of ribs.

FIG. 5 is a view of yet another alternative embodiment of the unitary body headliner wherein the secondary component is a bracket adapted to receive a magnetic fastener used to secure the finished headliner to the metal roof substrate of a motor vehicle.

FIG. 6 is a view of yet another alternative embodiment of the unitary body headliner wherein the secondary component is a trim ring adapted to receive and reinforce the opening for a sun roof assembly.

FIG. 7 is a detailed perspective view of a portion of an energy absorbing rib structure of the type that may be injection molded onto the B-surface of the unitary body headliner.

Reference will now be made in detail to the present preferred embodiments of the headliner and the method, examples of which are illustrated in the accompanying drawing figures.

### DETAILED DESCRIPTION

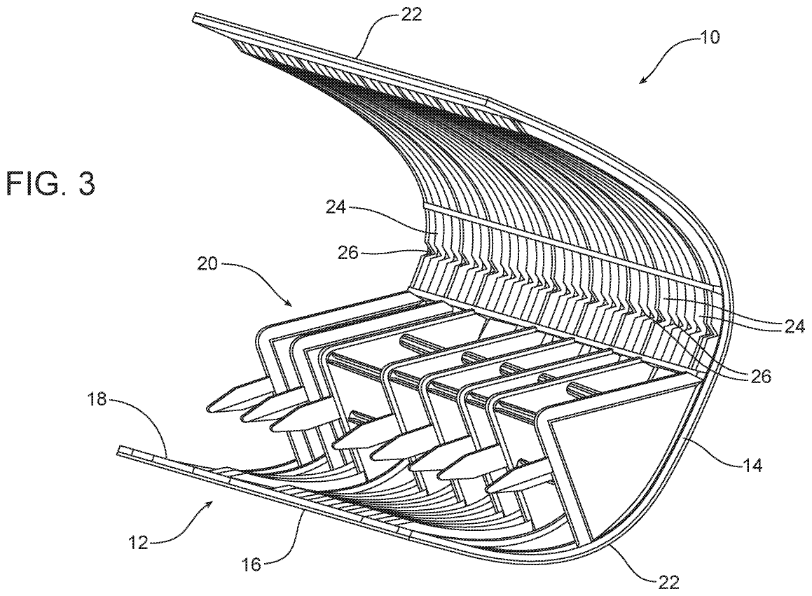

As noted above, this document relates to a method of producing a headliner 10 having a unitary body 12. As illustrated in FIG. 3, the unitary body includes a substrate 14 having an A surface 16 and a B surface 18. In addition, the unitary body 12 includes a secondary component 20 carried on the B surface 18 and a laminated surface covering 22 on the A surface 16.

More particularly, as will be described in greater detail below, the substrate 14 may be formed from a polypropylene glass matte technology (PP/GMT) blank. The secondary component 20 may be made from any appropriate plastic composite material suitable for injection molding and adapted for fusing with the PP/GMT material used to form the substrate. For purposes of this document it should be understood that the terminology “unitary body” means produced as a single integral component not requiring assembly from separate parts or components.

In the embodiment of the headliner 10 illustrated in FIG. 3, the secondary component 20 comprises a side air curtain deployment feature incorporating a plurality of ribs 24 having notches 26 configured to allow the substrate 14 to flex in a precise and repeatable manner for proper air curtain deployment. The ribs 24 may also function to absorb energy in the event of a head impact thereby providing protection for a vehicle occupant.

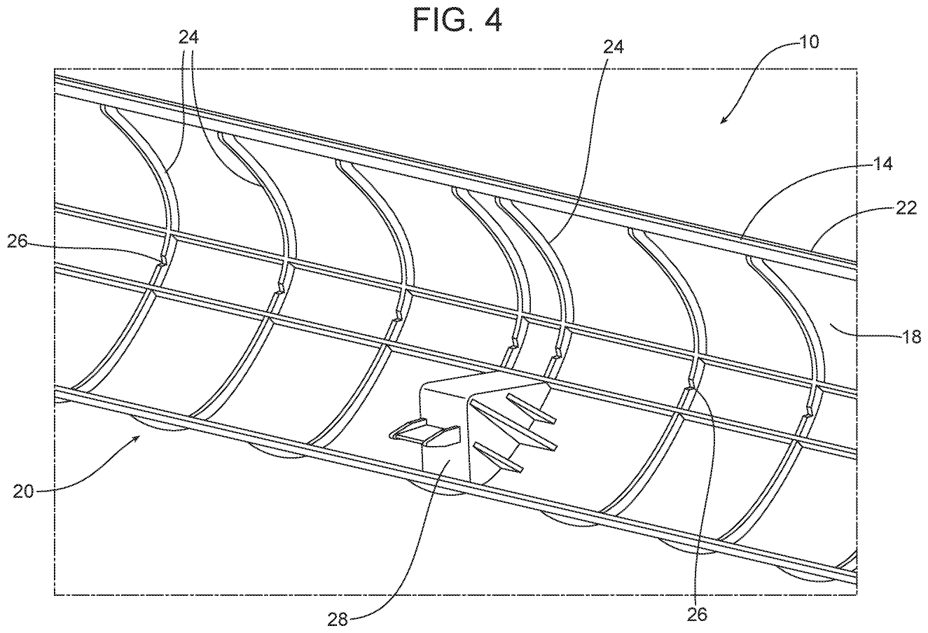

In the embodiment of the headliner 10 illustrated in FIG. 4, the secondary component 20 comprises an integral attachment feature in the form of a bracket 28 and an integral reinforcement in the form of a plurality of ribs 24. The bracket 28 may be adapted to secure the headliner to part of the metal super structure of the motor vehicle or adapted to receive a fastener to secure another component, such as a coat hook or grab handle, to the headliner. The reinforcement ribs 24 may be adapted to retain the shape of the headliner 10 when the headliner is secured to the roof substrate (not shown) of the motor vehicle. The ribs 24 may also include notches 26 if desired.

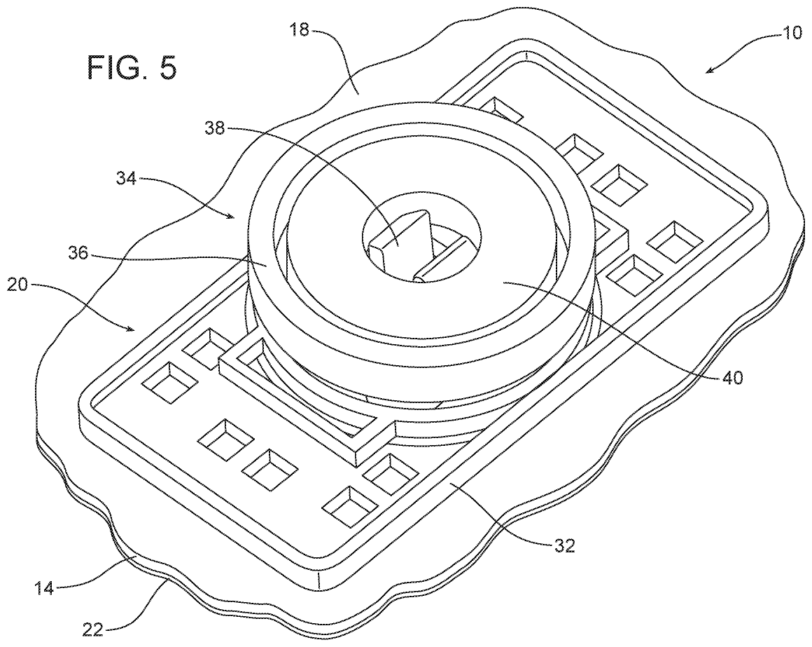

FIG. 5 illustrates yet another alternative embodiment of a headliner 10 wherein the secondary component 20 comprises a bracket 32 adapted to receive and hold a magnetic fastener 34 of a type utilized to secure the headliner to a sheet metal roof substrate of the motor vehicle. The magnetic fastener 34 is secured to the bracket 32. In the illustrated embodiment, that magnetic fastener 34 includes a cup or umbrella 36 fixed to the post 38 of the bracket 32. The cup 36 receives and holds a magnet 40.

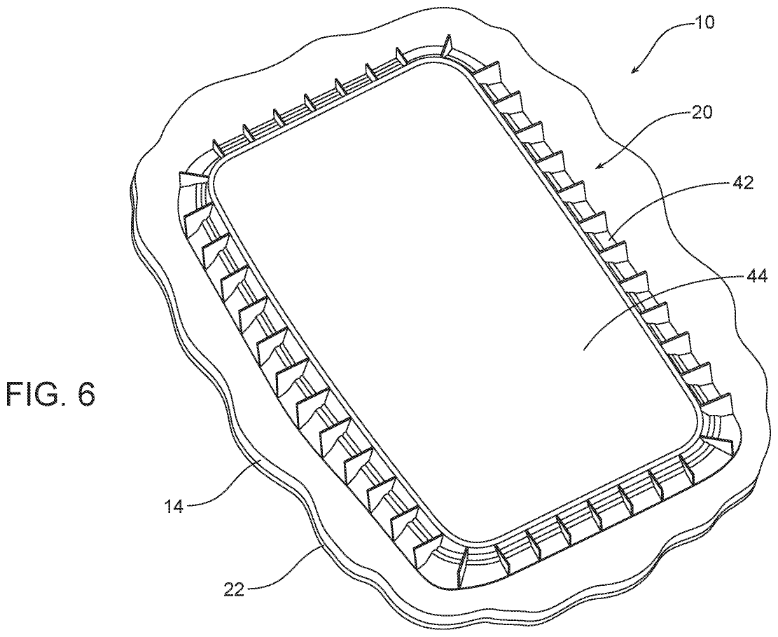

FIG. 6 illustrates yet another alternative embodiment of the headliner 10 wherein the secondary component 20 is a trim ring 42 that outlines an opening 44 that receives and holds a sun roof assembly (not shown). As should be appreciated, the trim ring 42 functions to reinforce the headliner 10 so that the headliner better holds its shape around the sun roof opening 44.

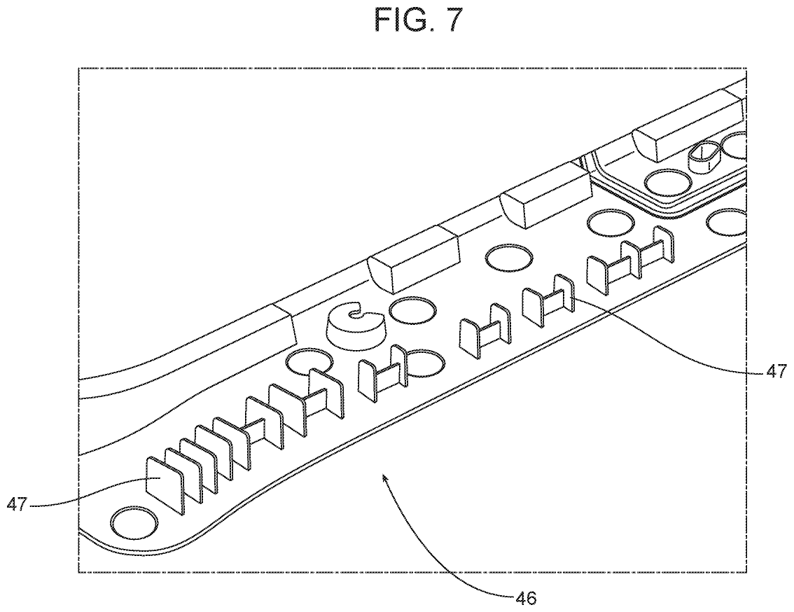

FIG. 7 illustrates an integral energy absorbing feature 46 that may be the secondary component 20 on yet another embodiment of the headliner 10. More particularly, that energy absorbing feature 46 includes a plurality of ribs 47 adapted to absorb energy in the event of an impact of the head or other part of an occupant against the headliner in an effort to mitigate injury.

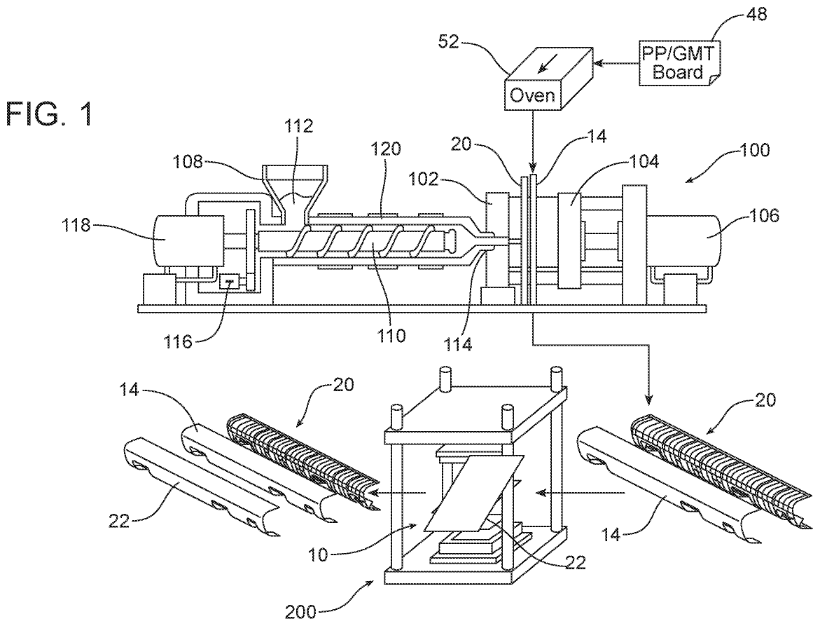

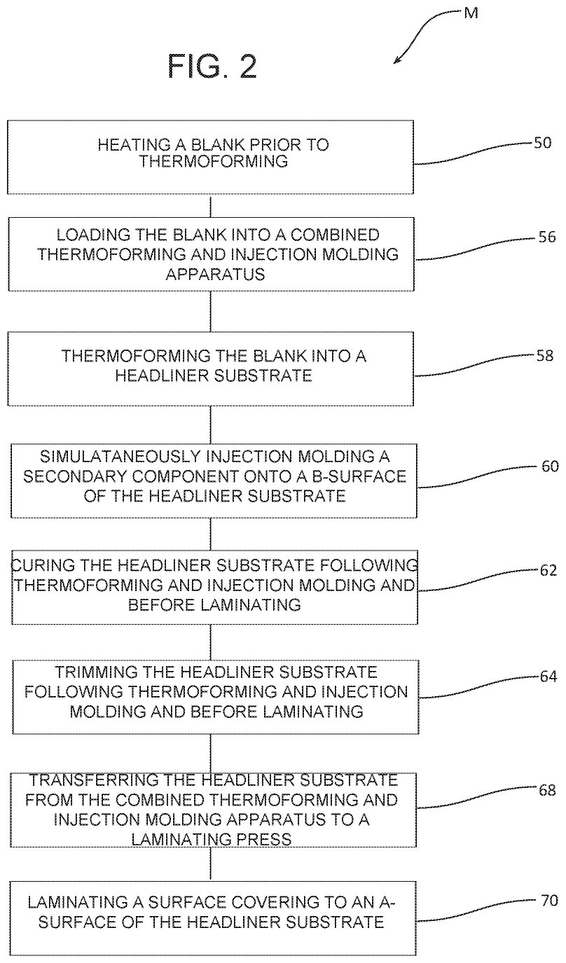

Any of the headliners 10 illustrated in FIGS. 3-7 may be produced by means of the new and improved method M illustrated in FIGS. 1 and 2. That method may be broadly defined as including the steps of simultaneously thermoforming a blank 48 into a headliner substrate 14 and injection molding a secondary component 20 onto the headliner substrate and then laminating a surface covering 22 to the headliner substrate. More particularly, as illustrated in these Figures, initially the method M includes heating the blank 48 to a desired temperature for processing the blank into the headliner substrate 14 (note box 50). This heating may be performed in the oven 52. This is followed by the step of loading the pre-heated blank 48 into the combined thermoforming and injection molding apparatus 100 (note box 56).

This is then followed by the step of thermoforming the blank 48 into a headliner substrate 14 (note box 58) and simultaneously injection molding the secondary component 20 onto the B surface 18 of the headliner substrate (note box 60). Toward this end, the combined thermoforming and injection molding apparatus 100 of the illustrated embodiment includes a stationary platen 102 and a cooperating displaceable platen 104 to complete the thermoforming and compression molding of the blank 48 into the substrate 14. A clamping cylinder 106 displaces the displaceable platen 104 in the desired manner.

The combined thermoforming and injection molding apparatus 100 also includes an injection molding section having a feed hopper 108, for receiving plastic material in the form of pellets or the like, a feed screw or auger 110 for delivering the plastic material 112 toward the injection molding nozzle 114, a drive motor 116 for turning the feed screw and a cylinder 118 for reciprocating the feed screw through the barrel 120.

The secondary component 20 injection molded to the B surface 18 of the headliner substrate 14 may be selected from a group of secondary components consisting of the side air curtain deployment feature illustrated in FIG. 3, the integral attachment feature or bracket 28 illustrated in FIG. 4, the integral reinforcement, such as the plurality of ribs illustrated in FIG. 4, the bracket 32, including the receiver or post 38 adapted to receive and hold the magnetic fastener 34, as illustrated in FIG. 5, a trim ring 42 as illustrated in FIG. 6, an integral energy absorbing feature 46 as illustrated in FIG. 7 and combinations thereof.

The method also includes the step of curing the headliner substrate 14 following thermoforming and injection molding and before laminating (note box 62) as well as the step of trimming the headliner substrate following thermoforming and injection molding and before laminating (note box 64). The trimming may be performed during the curing. Further, it should be appreciated that the trimming may include cutting any necessary holes in the headliner substrate 14 as required for the particular motor vehicle application for which the headliner is to be used.

As further illustrated, the method also includes the step of transferring the headliner substrate 14 from the combined thermoforming and injection molding apparatus 100 to a laminating press 200 (note box 68). This is then followed by the step of laminating the surface covering 22 to the A surface 16 of the headliner substrate 14 (note box 70).

That surface covering may comprise any appropriate material suited for the intended purpose including, for example, cloth, felt, alcantara or other appropriate material. The embodiment of the method illustrated in FIGS. 1 and 2 relates to the production of a headliner 10 with a unitary body 12. It should be appreciated that the method may also be utilized for other applications. Accordingly, the method may be more broadly described for producing a component (such as but not limited to the headliner 10) with a unitary body comprising the steps of thermoforming a blank into a component substrate, simultaneously injection molding a secondary feature onto the component substrate and then laminating a surface covering to the component substrate.

More particularly, the broader method may include heating the blank prior to the thermoforming and injection molding and then loading the preheated blank into a combined thermoforming and injection molding apparatus following heating. Further, the method may include trimming the component substrate following the thermoforming and injection molding and before laminating. In addition, the method may include transferring the component substrate from the combined thermoforming and injection molding apparatus into a laminating press for the laminating process.

Numerous benefits and advantages result from the method of producing a headliner 10 with a unitary body 12 as described herein. The new method allows for the reduction of engineering and design inefficiencies. The method reduces component part proliferation by providing an integral unitary body thereby reducing both the piece cost and mass of the headliner 10 or overhead system.

Significantly, the method allows for a reduction in component tooling, assembly tooling and assembly capital equipment investment. Further, the method allows for directing indirect labor reduction while also eliminating the need for many different adhesives and mechanical fasteners thereby simplifying assembly processes. The method also results in reduced shipping requirements thereby eliminating any fuel and shipping container expenses. The above should be considered to be an exemplary list of the benefits and advantages provided by the method rather than an exhaustive recitation of those benefits and advantages.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A headliner, comprising:
a unitary body including (a) a substrate having an A-surface and a B-surface, (b) a secondary component carried on said B-surface and (c) a laminated surface covering on said A-surface.

2. The headliner of claim 1, wherein said secondary component is a side air curtain deployment feature.

3. The headliner of claim 1, wherein said secondary component is an integral attachment feature.

4. The headliner of claim 3, wherein said integral attachment feature is a bracket.

5. The headliner of claim 4, wherein said bracket includes a receiver adapted to receive and hold a magnetic fastener.

6. The headliner of claim 1, wherein said secondary component is an integral reinforcement.

7. The headliner of claim 6, wherein said integral reinforcement is a plurality of ribs.

8. The headliner of claim 1, wherein said secondary component is an integral energy absorbing feature.

9. The headliner of claim 1, wherein said secondary component is a trim ring.

10. The headliner of claim 9, wherein said trim ring includes a receiver adapted to receive a sun roof assembly.

11. A method of producing a headliner with a unitary body, comprising:
thermoforming a blank into a headliner substrate;
simultaneously injection molding a secondary component onto said headliner substrate wherein said secondary component is selected from a group consisting of a side air curtain deployment feature, an integral attachment feature, a bracket, a bracket including a receiver adapted to receive and hold a magnetic fastener, an integral reinforcement, a plurality of ribs, a trim ring, an integral energy absorbing feature and combinations thereof; and
laminating a surface covering to said headliner substrate.

12. The method of claim 11, including heating said blank prior to thermoforming and injection molding.

13. The method of claim 12, including loading said blank into a combined thermoforming and injection molding apparatus following said heating.

14. The method of claim 13, including trimming said headliner substrate following said thermoforming and injection molding and before laminating.

15. The method of claim 14, including transferring said headliner substrate from said combined thermoforming and injection molding apparatus into a laminating press for said laminating.
